(19) United States
(12) Patent Application Publication
(10) Pub. No.: US 2012/0242668 A1
(43) Pub. Date: Sep. 27, 2012

(54) DATA PRESENTATION METHOD AND PARTICIPANT RESPONSE SYSTEM EMPLOYING SAME

(75) Inventor: MICHAEL ROUNDING, Calgary (CA)

(73) Assignee: SMART TECHNOLOGIES ULC, Calgary (CA)

(21) Appl. No.: 13/070,005

(22) Filed: Mar. 23, 2011

(51) Int. Cl. G06T 11/20

(52) U.S. Cl. 345/440

(57) ABSTRACT

A method of presenting data gathered by a participant response system, comprising obtaining spatial information for participants; collecting response data from the participants and generating result data; overlaying the result data on a map image in accordance with the obtained spatial information to form a data map; and displaying the data map.

### FIELD OF THE INVENTION

The present invention relates generally to participant response systems and in particular to a data presentation method and a participant response system employing the same.

### BACKGROUND OF THE INVENTION

Participant response systems for enabling participants of an event to enter responses to posed questions, motions or the like are well known in the art and have wide applicability. For example, during a conference, seminar or the like, participants can be provided with handsets that enable the participants to respond to questions, or to vote on motions raised during the conference or seminar. In the entertainment field, audience members can be provided with handsets that enable the audience members to vote for entertainment programmes or sports events. These participant response systems are also applicable in the field of education. Participants can be provided with handsets that enable the participants to respond to questions posed during lessons, tests or quizzes. Of significant advantage, these participant response systems provide immediate feedback to presenters, teachers, entertainment programme producers, or event organizers. With respect to the field of education, research shows that teachers teach and participants learn more effectively when there is rapid feedback concerning the state of participants' comprehension or understanding. It is therefore not surprising that such participant response systems are gaining wide acceptance in the field of education.

Participant response systems fall generally into two categories, namely wired and wireless participant response systems. In wired participant response systems, participants respond to posed questions or vote on motions using remote units that are physically connected to a local area network and communicate with a base or host general purpose computing device. In wireless participant response systems, the remote units communicate with the base or host general purpose computing device wirelessly.

A number of different wired and wireless participant response systems have been considered. For example, U.S. Pat. No. 4,247,908 to Lockhart, Jr. et al. discloses a two-way communication system for use with a host general purpose computing device that includes a control unit, a base station and multiple, hand-held, portable radio/data terminal units. The control unit interfaces directly with the host general purpose computing device but uses a radio link to interface with the portable radio/data terminal units. Each portable radio/data terminal unit includes a two-way radio and a data terminal. The data terminal includes a keyboard for data entry and an LED display for readout of either received data or locally generated data. The host general purpose computing device initiates communication through polling and/or selection of portable radio/data terminal units via the control unit. The control unit, in response to a “poll” from the host general purpose computing device, responds by sending either a previously received message from a portable radio/data terminal unit, or if no message has been received, a “no message” response. Polling by the control unit is an invitation to the portable radio/data terminal units to send data to the control unit to be stored, grouped if necessary and sent on to the host general purpose computing device. The control unit polls the portable radio/data terminal units by address in a particular sequence. The control unit transmits acknowledgements to the portable radio/data terminal units for received data on the next polling cycle.

U.S. Pat. No. 5,002,491 to Abrahamson et al. discloses an interactive electronic classroom system for enabling teachers to teach participants concepts and to receive immediate feedback regarding how well the participants have learned the taught concepts. Structure is provided for enabling participants to proceed in lockstep or at their own pace through exercises and quizzes, responding electronically to questions asked, the teacher being able to receive the responses, and to interpret a readout, in histogram or other graphic display form, of participant responses. The electronic classroom comprises a central computer and a plurality of participant computers, which range from simple devices to full fledged personal computers, connected to the central computer over a network. Optional peripheral hardware, such as video cassette recorders (VCRs) or other recording/reproducing devices, may be used to provide lessons to participants in association with the computer network.

U.S. Pat. No. 6,790,045 to Drimmer discloses a method and system for analyzing participant performance by classifying participant performance into discrete performance classifications associated with corresponding activities related to an electronic course. An observed participant performance level for at least one of the performance classifications is measured. A benchmark performance level or range is established for one or more of the performance classifications. It is then determined whether the observed participant performance level is compliant with the established benchmark performance level for the at least one performance classification. Instructive feedback is determined for the observed participant based upon any material deviation of the observed participant performance from at least one benchmark.

U.S. Patent Application Publication No. 2004/0072136 to Roschelle et al. discloses a method and system for assessing a participant's understanding of a process that may unfold over time and space. The system comprises thin client devices in the form of wireless, hand-held, palm-sized computers that communicate with a host workstation. The system provides a sophisticated approach of directing participants to perform self-explanation, and enables instructors to enhance the value of this pedagogical process by providing meaningful and rapid feedback in a classroom setting.

U.S. Patent Application Publication No. 2004/0072497 to Buehler et al. discloses a response system and method of retrieving user responses from a plurality of users. The response system comprises a plurality of base units and a plurality of response units. Each of the response units is adapted to receive a user input selection and to communicate that user's input selection with at least one base unit utilizing wireless communication. Personality data is provided for the response units to facilitate communication with a particular base unit. The personality data of a particular response unit is changed when it is desired to change the base unit to which that response unit communicates. This allows a response unit to become grouped with a particular base unit at a particular time and become grouped with another base unit at another particular time.

Although known participant response systems are capable of analyzing student responses, some known participant response systems may not be capable of visually representing analysis results according to spatial information of participants. For example, in the case of a school classroom, some known participant response systems may not be capable of visually representing analysis results as a function of student location in a classroom, in a school, or in other geographic areas such as a school district or a city. A participant response system capable of such visual representation may better enable the teacher to identify possible relationships between student academic performance and seat location, for example, or may better enable a school board administrator to identify possible relationships between student academic performance and school location or student demographics.

Additionally, conventional database systems typically require a defined data structure. If a user needs to expand a table in a database to include data of a type that has not been defined therein, the user needs to first modify the structure to include additional fields for accommodating the data, and then enter the data into the modified structure. As will be appreciated, a participant response system utilizing a more flexible database configuration is desirable.

It is therefore an object of the present invention to provide a novel data presentation method and a participant response system employing same.

### SUMMARY OF THE INVENTION

Accordingly, in one aspect there is provided a method of presenting data gathered by a participant response system, comprising obtaining spatial information for participants; collecting response data from the participants and generating result data; overlaying the result data on a map image in accordance with the obtained spatial information to form a data map; and displaying the data map.

In one embodiment, the spatial information comprises at least one of spatial coordinates and geographic coordinates of the participants. The spatial information may be stored as at least one tag forming part of a tag string created for each participant. In this case, the method may further comprise analyzing the tag strings, and associating tags comprising the spatial information with the map image. The method may also further comprise parsing the tag string of each participant into at least one tag, partitioning each tag into a keyword and a tag value and/or creating the map image based on the tag values of tags comprising spatial information.

In another embodiment, the method further comprises selecting data other than the result data to be displayed, overlaying the selected data on the map image in accordance with the spatial information to form a second data map, and displaying the second data map.

The response data may comprise answer data to at least one question. In this case, the method may further comprise, prior to the collecting, administrating an assessment to the participants, the assessment comprising the at least one question, and analyzing the response data with regard to the answer to the at least one question to generate the result data.

According to another aspect, there is provided a participant response system comprising a display; a plurality of participant response devices, each participant response device configured to generate response data in response to user input; and processing structure communicating with the display and the participant response devices, said processing structure being configured to analyze response data received from participant response devices and generate result data, overlay the result data on a map image in accordance with spatial information to form a data map, and display the data map on the display.

According to yet another aspect, there is provided an apparatus comprising a display; and processing structure communicating with the display, the processing structure executing program code causing the apparatus to analyze response data received from participant response devices and generate result data; overlay the result data on a map image in accordance with spatial information to form a data map; and display the data map on the display.

According to still yet another aspect, there is provided a computer-readable medium having embodied thereon computer program code which, upon execution by processing structure, causes an apparatus to collect response data from participant response devices and generate result data; overlay said result data on a map image in accordance with spatial information to form a data map; and display said data map.

### BRIEF DESCRIPTION OF THE DRAWINGS

Embodiments will now be described more fully with reference to the accompanying drawings in which:

FIG. 1 is a schematic plan view of a participant response system;

FIG. 2 is another schematic view of the participant response system of FIG. 1;

FIG. 3 is a perspective view of an interactive whiteboard forming part of the participant response system of FIG. 1;

FIGS. 4A and 4B are side elevational and top plan views, respectively, of a transceiver forming part of the participant response system of FIG. 1;

FIG. 5 is a block diagram of the transceiver of FIGS. 4A and 4B;

FIG. 6 is a front elevational view of a remote unit for use with the participant response system of FIG. 1;

FIG. 7 is a schematic view of a software architecture used by the participant response system of FIG. 1;

FIG. 8 is a participant response window presented by the participant response system of FIG. 1;

FIG. 9 is a management module window presented by the participant response system of FIG. 1;

FIG. 10 is a window presented by the participant response system of FIG. 1, showing a host-side application pop-up menu;

FIG. 11 is a schematic diagram showing a database structure;

FIG. 12 is an exemplary participant information tag string;

FIG. 13A is a flowchart showing the steps of a data management process;

FIG. 13B is a flowchart showing the steps of a tag analysis process;

FIG. 13C is a flowchart showing the steps of a data display process;

FIG. 13D is a flowchart showing the steps of a data plotting process;

FIG. 14 is a data map presented by the participant response system of FIG. 1;

FIG. 15 is another data map presented by the participant response system of FIG. 1;

FIG. 16 is yet another data map presented by the participant response system of FIG. 1; and

FIG. 17 is another embodiment of a management module window presented by the participant response system of FIG. 1.

### DETAILED DESCRIPTION OF THE EMBODIMENTS

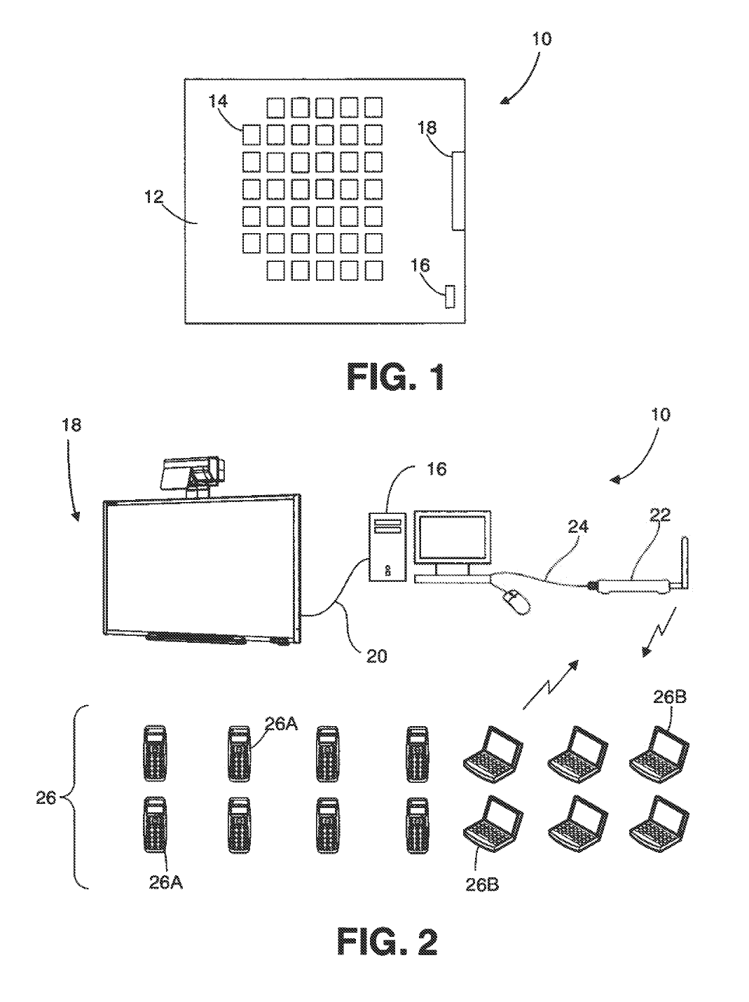

Turning now to FIGS. 1 and 2, a participant response system is shown and is generally identified by reference numeral 10. In this embodiment, participant response system 10 is employed in a room 12, e.g., a classroom, lecture hall or theatre of an educational institution such as for example a school, university, college or the like, having a plurality of seats 14. As can be seen, the participant response system 10 comprises a general purpose computing device 16, an interactive whiteboard or board (IWB) 18 physically connected to the general purpose computing device 16 via a cable 20, a radio frequency (RF) transceiver 22 physically connected to the general purpose computing device 16 via a universal serial bus (USB) cable 24, and a plurality of wireless, participant response devices 26 communicating with the general purpose computing device 16 via the transceiver 22. In the embodiment shown, the participant response devices 26 comprise remote units 26A and portable computing devices such as laptop computers, tablets etc. 26B. Generally, each participant response device 26 is assigned to a seat 14.

The participant response system firmware for communicating with remote units 26A in this embodiment is implemented on top of IEEE 802.15.4 media access control (MAC) protocol layer software provided by Texas Instruments (TI). The TI MAC protocol layer software comprises a small real-time kernel and so called Z-stack™ ZigBee compliant protocol stack to provide simple real-time operating system (OS) facilities such as for example, timer management, task management and interrupt management. Abstraction layers are used to separate the OS and the hardware drivers for ease of porting to a different OS and hardware platform.

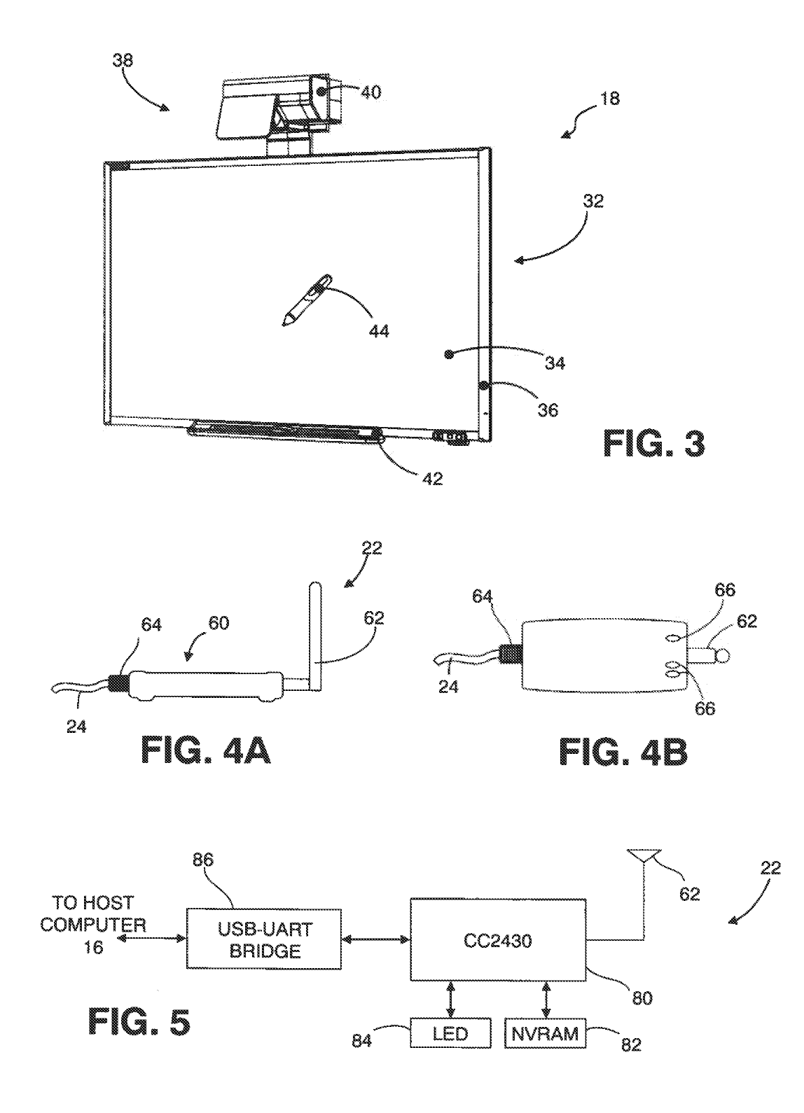

As is best seen in FIG. 3, IWB 18 is mounted on a vertical support surface such as for example, a wall surface or the like. IWB 18 comprises a generally planar, rectangular interactive surface 34 that is surrounded about its periphery by a bezel 36. An ultra-short-throw projector 40 such as that sold by SMART Technologies ULC of Calgary, Alberta, Canada under the name “SMART UX60”, is also mounted on the support surface above the IWB 18 and projects an image, such as for example, a computer desktop, onto the interactive surface 34.

The IWB 18 employs machine vision to detect one or more pointers brought into a region of interest in proximity with the interactive surface 34. The IWB 18 communicates with the general purpose computing device 16, which executes one or more application programs, via the USB cable 20. General purpose computing device 16 processes the output of the IWB 18 and adjusts image data that is output to the projector 40, if required, so that the image presented on the interactive surface 34 reflects pointer activity. In this manner, the IWB 18, general purpose computing device 16 and projector 40 allow pointer activity proximate to the interactive surface 34 to be recorded as writing or drawing or used to control execution of one or more application programs executed by the general purpose computing device 16.

The bezel 36 in this embodiment is mechanically fastened to the interactive surface 34 and comprises four bezel segments that extend along the edges of the interactive surface 34. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces extend in a plane generally normal to the plane of the interactive surface 34.

A tool tray 42 is affixed to the IWB 18 adjacent the bottom bezel segment using suitable fasteners such as for example, screws, clips, adhesive etc. As can be seen, the tool tray 42 comprises a housing having an upper surface configured to define a plurality of receptacles or slots. The receptacles are sized to receive one or more pen tools 44 as well as an eraser tool (not shown) that can be used to interact with the interactive surface 34. Control buttons (not shown) are provided on the upper surface of the housing to enable a user to control operation of the IWB 18. Further details of the tool tray 42 are provided in U.S. patent application Ser. No. 12/709,424 to Bolt et al., filed on Feb. 19, 2010, and entitled “INTERACTIVE INPUT SYSTEM AND TOOL TRAY THEREFOR”, the content of which is herein incorporated by reference in its entirety.

Imaging assemblies (not shown) are accommodated by the bezel 36, with each imaging assembly being positioned adjacent a different corner of the bezel. Each of the imaging assemblies has an infrared light source and an imaging sensor having an associated field of view. The imaging assemblies are oriented so that their fields of view overlap and look generally across the entire interactive surface 34. In this manner, any pointer such as for example a user's finger, a cylinder or other suitable object, or a pen tool 44 or eraser tool lifted from a receptacle of the tool tray 42, that is brought into proximity of the interactive surface 34 appears in the fields of view of the imaging assemblies.

The general purpose computing device 16 in this embodiment is a personal computer or other suitable processing device or structure comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The general purpose computing device 16 may also comprise networking capability using Ethernet, WiFi, and/or other network format, for connection to access shared or remote drives, one or more networked computers, or other networked devices.

Turning now to FIGS. 4A, 4B and 5, the transceiver 22 is better illustrated. Transceiver 22 comprises a casing 60 adapted to be desktop or wall mounted. An L-shaped omni-directional antenna 62 is mounted on the front end of the casing 60. The rear end of the casing 60 receives the USB cable 24 via connector 64. A plurality of light emitting diodes (LEDs) 66 are provided on the top surface of the casing 60 with the LEDs being illuminated to provide visual feedback concerning the operational status of the transceiver 22. In this embodiment, the LEDs 66 comprise a power status LED and communications status LEDs. Alternatively, the transceiver 22 may provide visual feedback via a display such as a liquid crystal display (LCD) or via both LEDs and an LCD. The transceiver electronics are accommodated by the casing 60 and comprise a microprocessor 80 that communicates with non-volatile, random access memory (NVRAM) 82, an LED driver 84, the antenna 62 and a USB-UART bridge 86. Power is provided to the transceiver 22 via the USB connection.

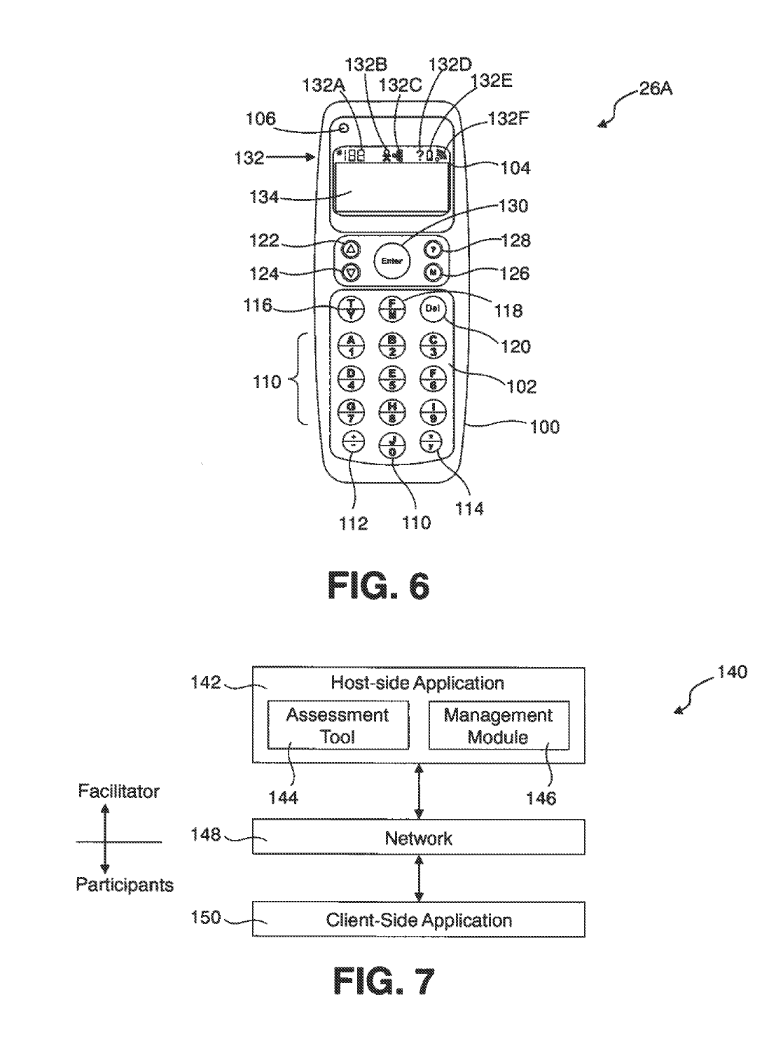

One of the remote units 26A is better illustrated in FIG. 6. Remote unit 26A comprises a casing 100 having a keypad 102, an LCD or other suitable display 104, a power button 106 and an optional battery status LED (not shown) on its front surface. In this embodiment, keypad 102 comprises ten dual character (A to J/0 to 9) buttons 110, a plus/minus (+/−) button 112, a fraction/decimal (x/y) button 114, a true/yes (T/Y) button 116, a false/no (F/N) button 118, a delete (Del) button 120, up and down scroll (̂/v) buttons 122 and 124, a menu button 126, a question/hands up (?) button 128 and an enter button 130.

The display 104 comprises an upper row of LCD icons 132 disposed above a character display area 134. The LCD icons 132 comprise a plurality of status indicators such as for example a question number icon 132A, a user status icon 132B, a network status icon 132C, a hands-up (?) icon 132D, a battery status icon 132E and a transmission status icon 132F. The character display area 134 comprises a 128×48 pixel array that is divided into three lines. Each line can display a total of sixteen (16) characters.

The casing 100 of the remote unit 26A defines an enclosure in which electronics (not shown) are housed. In this embodiment, the electronics housed within the casing 100 comprise a microprocessor, an LCD control module, an omni-directional antenna and memory. Power is provided to the remote unit 26A by non-rechargeable and/or rechargeable batteries (not shown) also housed within the casing 100. The remote unit 26A is also configured to be powered by a standard 110V/220V power source via a power cord (not shown). When the batteries used are rechargeable batteries and the remote unit 26A is connected to the standard 110/220V power source, the remote unit 26A charges the batteries while being able to simultaneously communicate with the general purpose computing device 16. When battery charging has been completed, an indication of such is provided to the user and the remote unit 26A is then able to be disconnected from the power cord and used in a wireless manner.

FIG. 7 shows the software architecture used by the participant response system 10, which is generally indicated by reference numeral 140. Software architecture 140 comprises a host-side application 142 running on the general purpose computing device 16. The host-side application 142 is in communication with one or more client-side applications 150 running on the response devices 26 via a network 148. The host-side application 142 sends questions to the response devices 26, receives responses from the response devices 26, analyzes received responses, and presents results of the analysis or other selected data to a user of the general purpose computing device 16. In this embodiment, the user of the general purpose computing device 16 is a facilitator of the group of participants.

In the case of the remote units 26A, the client-side application 150 is implemented as firmware stored in the memory of each remote unit 26A, and is executed by the microprocessor when the remote unit 26A is booted up. The client-side application 150 receives via the omni-directional antenna 62 the questions sent by the host-side application 142, stores received questions in the memory, and displays them on the character display area 134 via the LCD control module. The client-side application 150 collects user input entered via the keypad 102, stores the user input in the memory, and when the Enter key 130 is pressed, transmits the user input to the host-side application 142. Further specifics of the remote unit 26A are disclosed in PCT Patent Application Publication No. WO12008/083486 to Doerksen et al. entitled “Participant Response System Employing Battery Powered, Wireless Remote Units” filed on Jan. 10, 2008, and assigned to SMART Technologies ULC of Calgary, Alberta, Canada, assignee of the subject application, the content of which is incorporated herein by reference in its entirety.

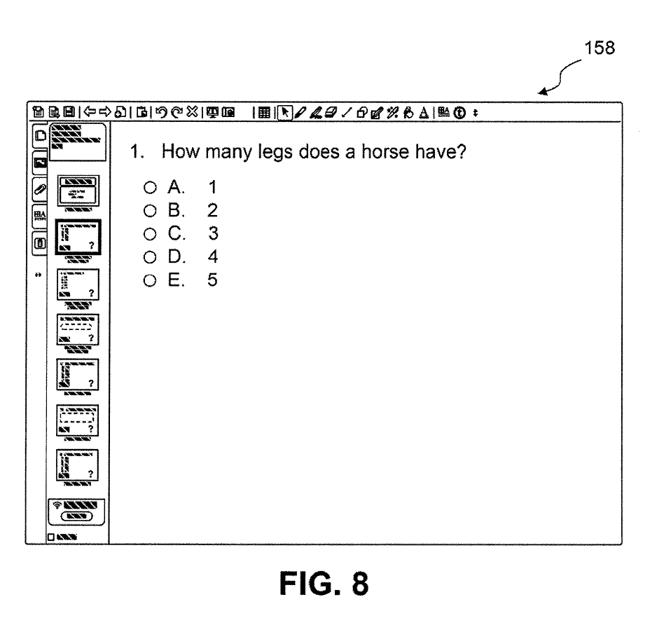

In the case of the portable computing devices 26B, the client-side application 150 is implemented as a software application running on the portable computing devices 26B. In this embodiment, the software application running on the portable computing devices 26B is SMART Notebook™ Student Edition software, offered by SMART Technologies ULC. In this implementation, the client-side application 150 presents a graphical user interface (GUI) window shown in FIG. 8 that is generally indicated using reference numeral 158. Window 158 is configured to display questions and user input responses, and is presented to participants during an assessment.

Referring again to FIG. 7, the host-side application 142 comprises an assessment tool 144 and a management module 146. In this embodiment, the assessment tool 144 is SMART Notebook™ software offered by SMART Technologies ULC. The assessment tool 144 comprises a graphical user interface (GUI) for facilitating interaction with the IWB 18. When the assessment tool 144 is being employed, the GUI of the assessment tool 144 is output by the general purpose computing device 16 and conveyed to the IWB 18, which in turn is used by the projector 40 to display the GUI on interactive surface 34. In this manner, the IWB 18 can be used by the facilitator to create and administer assessments and to analyze assessment results.

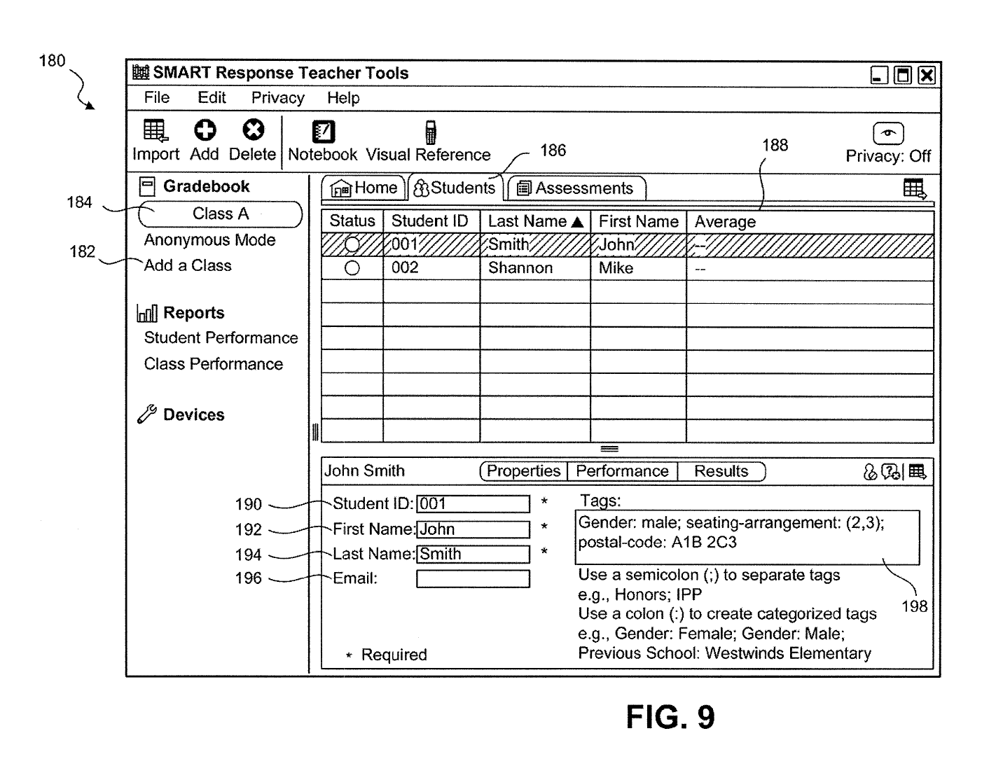

The management module 146 also comprises a GUI in the form of a management module window that is presented on the display screen of the general purpose computing device 16 (and/or optionally the interactive surface) when the management module 146 is being employed. The management module 146 provides a variety of functions selectable by the facilitator for generally managing participants, groups, response devices, and assessments. FIG. 9 shows the management module window, which is generally indicated by reference numeral 180. Management module window 180 comprises an add-group button 182 that may be selected to create a new participant group. In the embodiment shown, Add-group button 182 is labelled “Add a Class”. Management module window 180 also comprises a list 184 of groups, each of which may be selected for viewing or editing. In the embodiment shown, the list 184 comprises a single group “Class A”. Management module window 180 also comprises a participants tab 186 that may be selected to display a list 188 of participants of the group selected from list 184. In the embodiment shown, participants tab 186 is labelled “students”. Each of the participants in list 188 may be selected to view and edit additional information about that participant. In the embodiment shown, the additional information comprises student ID 190, First Name 192, Last Name 194, Email 196, and Tags 198.

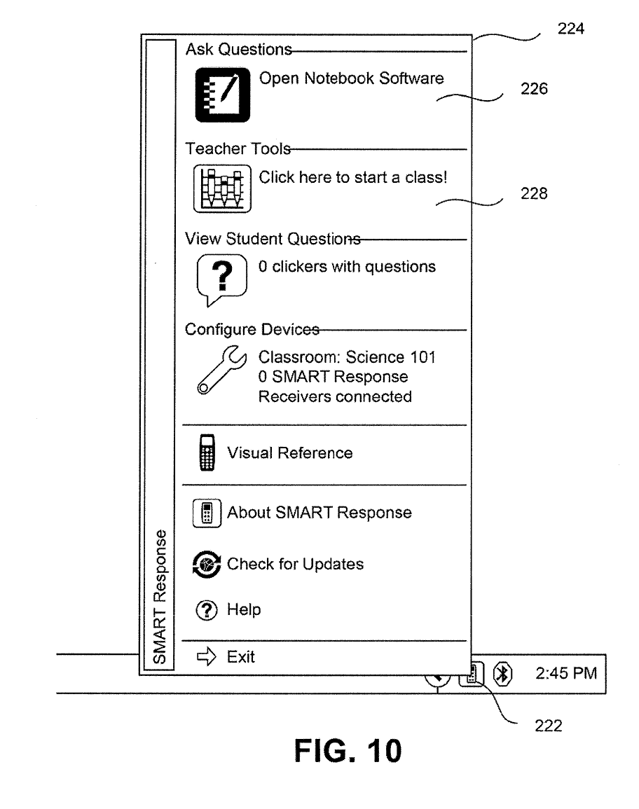

As described above, the host side application 142 runs on the general purpose computing device 16 which, in this embodiment, uses a Microsoft® Windows® XP operating system. As shown in FIG. 10, a desktop icon 222 representing the host-side application 142 is displayed in the system tray of the Microsoft® Windows® XP operating system. Clicking on the icon 222 displays a host-side application pop-up menu 224 for accessing the assessment tool 144 and the management module 146 of the participant response system 10. Host-side application pop-up menu 224 comprises an Ask Questions icon 226 that may be selected to launch the assessment tool 144. Host-side application pop-up menu 224 also comprises a Facilitator Tools icon 228 that may be selected to launch the management module 146 for managing participants and groups, and for viewing data.

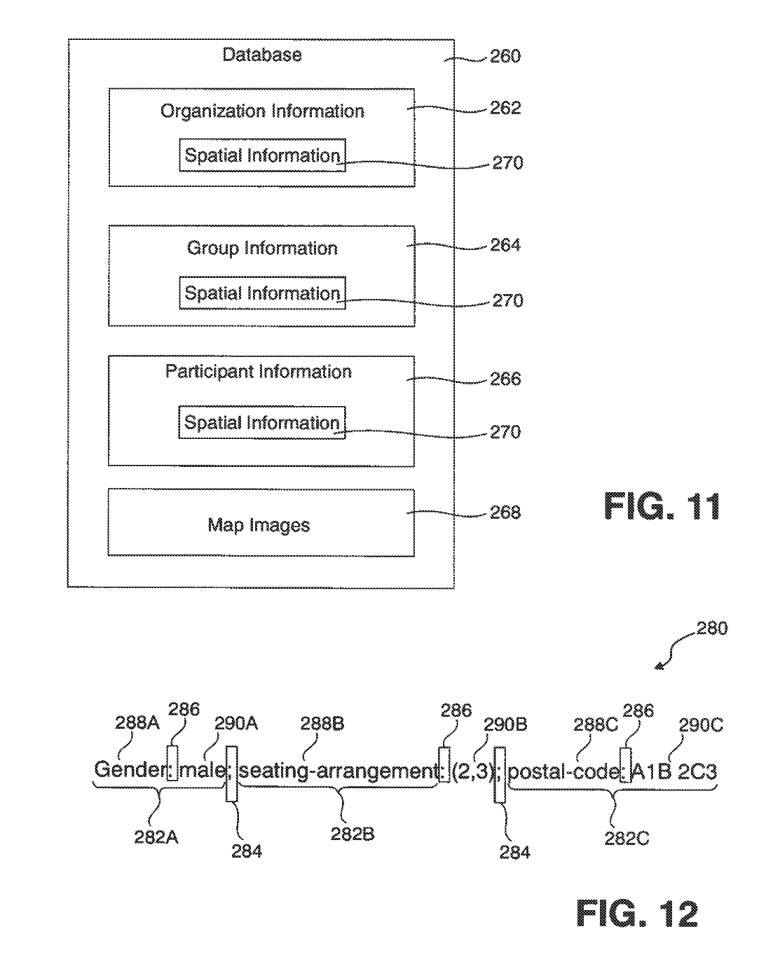

Participant response system 10 further comprises a database stored by the general purpose computing device 16, which is shown in FIG. 11 and generally indicated by reference numeral 260. Database 260 is configured to store data used by the participant response system 10 and recorded therein by the management module 146. In particular, the database 260 is configured to store data categorized as: organization information 262, which may for example comprise a school name, a school address, teacher identity (ID) information, teacher schedules, tags, etc.; group information 264, which may for example comprise the name, schedule, room number, the names of students of a class set up by the teacher, tags, etc.; and participant information 266, which may for example comprise participant IDs, participant names, tags, etc. Database 260 is also configured to store map images 268, which may for example be conventional geographic maps or other forms of spatial representation. For example, the spatial representation may be an image of a classroom showing seats, a floor plan of a building, a map of a school, or a map of a city, a state or a province, or a country relevant to a school or a class.

The data categories 262, 264 and 266 further comprise spatial information 270 including spatial coordinates such as, for example, seat coordinates in a classroom, or for example geographic coordinates of a school on a map.

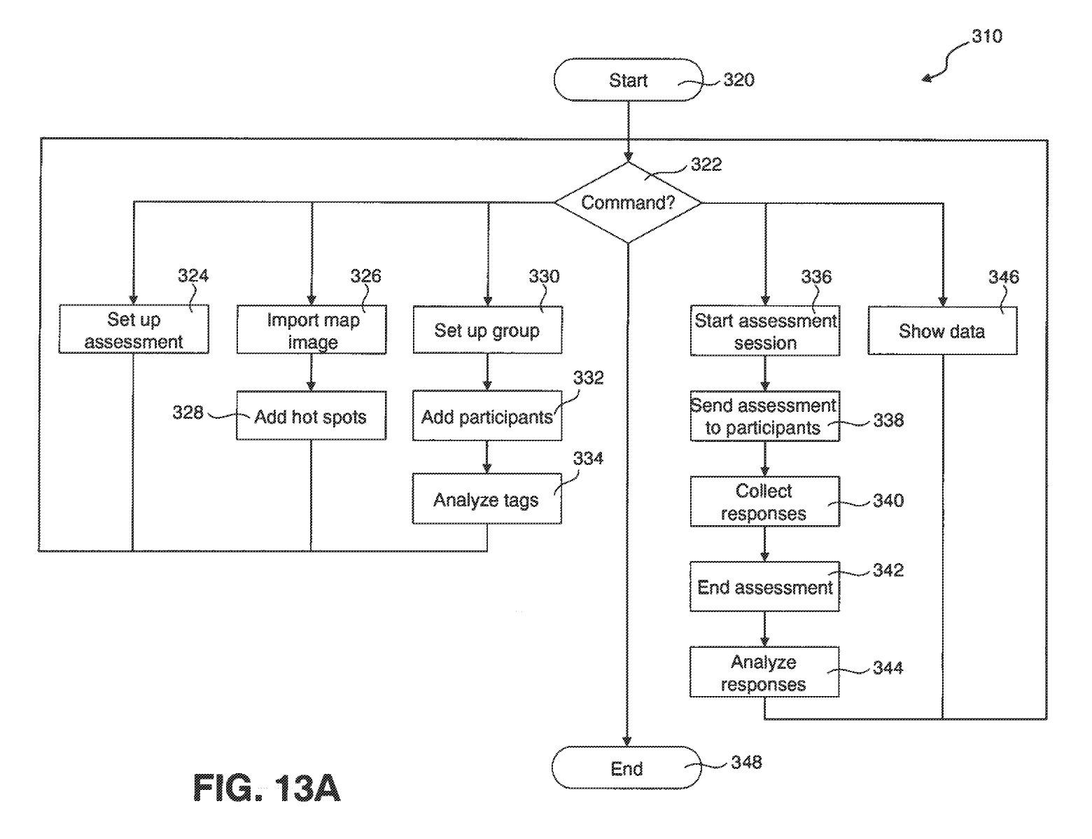

Some data within each of the data categories 262, 264 and 266 is organized using tags data fields. Each tags data field comprises a tag string in which information about each of the organizations, groups and participants, is represented. FIG. 12 shows an example of tag string 280 entered into a participant information tags data field. In the embodiment shown, the tag string 280 comprises three (3) tags 282A to 282C separated by a first delimiter 284. Each tag 282A to 282C comprises a respective keyword 288A to 288C and a respective tag value 290A to 290C separated by a second delimiter 286. In this embodiment, the keywords and tag values are entered by the facilitator.

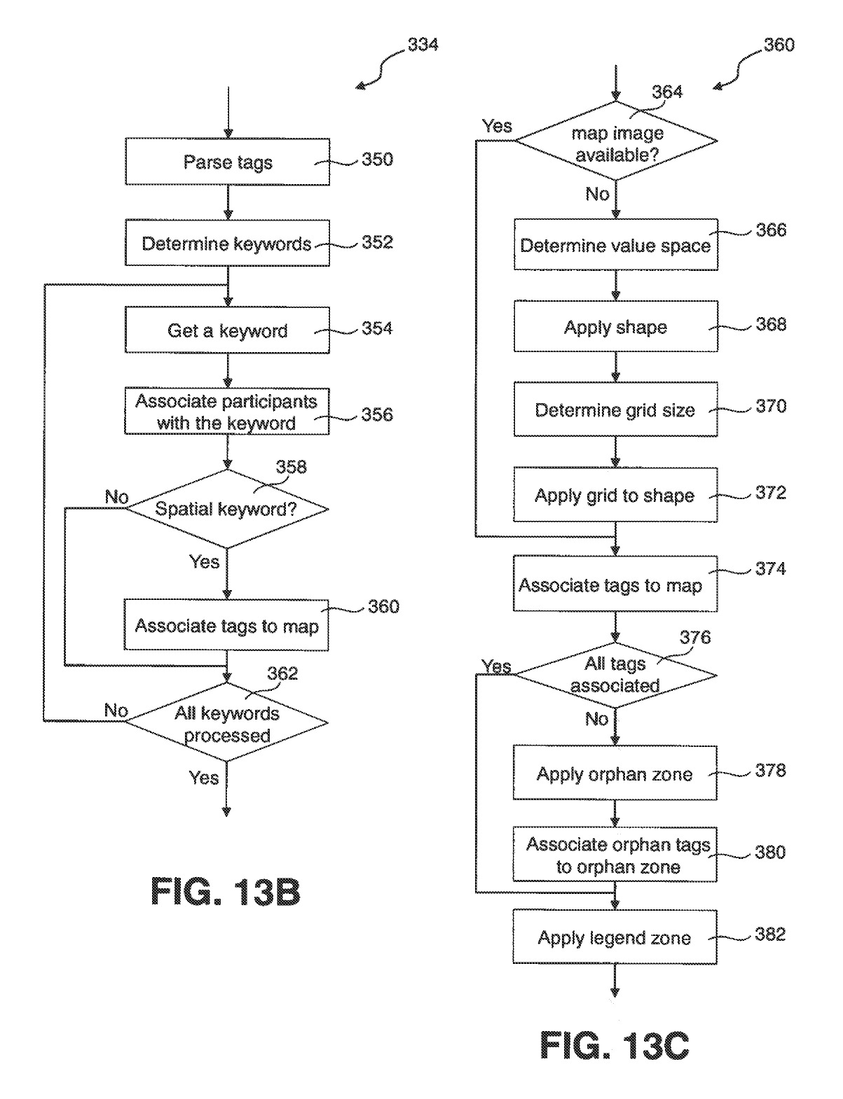

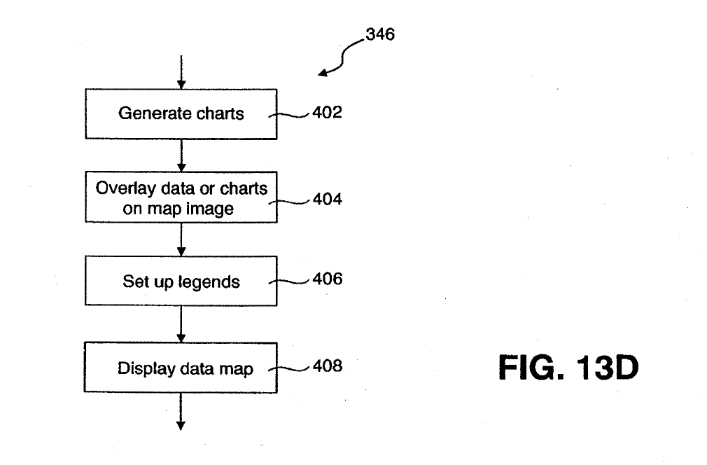

The host-side application 142 uses a data management process for generally managing data used by the participant response system 10. A flowchart showing the steps of the data management process is shown in FIG. 13A, and is generally indicated using reference numeral 310. Process 310 starts when the host-side application 142 is started on the general purpose computing device 16 (step 320). Once started, the desktop icon 222 representing the host-side application 142 is displayed in the system tray of the Microsoft® Windows® XP operating system, as shown in FIG. 10, and the process awaits input of a command from the facilitator (step 322). By selecting the icon 226 on the pop-up menu 224, the assessment tool 144 is launched for enabling the facilitator to create or edit an assessment (step 324). In this embodiment, each assessment is a SMART Notebook™ document comprising one or more questions of any of a true/false type, a yes/no type, a multiple choice type, a short answer type, and a math question type. Following step 324, the process returns to step 322 to await input of another command.

By selecting either an “import map” button (not shown) in the “Home” tab of the management module window 180, or an “import map” function (not shown) in a menu of the management module window 180, an “import map” dialogue box (not shown) is displayed for enabling a map image selected by the facilitator to be imported into the database 260 (step 326). The map image may be imported into the database 260 from any storage medium in communication with the database 260, such as for example a flash drive or a hard drive, or from a network page or a folder at a network location, or may be imported into the database 260 by copying the map image from an image viewing and/or image processing application and pasting the image into the database 260. Once the map image has been imported, the facilitator is then able to add one or more hot spots to the map image (step 328). Each of the hot spots is a point at which data is to be associated with the map image. For example, hot spots may be added to an image of a classroom to designate seat locations, and hot spots may for example be added to a city map image to designate postal code zones.

In this embodiment, a plurality of map images may be imported and then linked together to form a combined map image of greater size and having a map structure over a range of scales for enabling the facilitator to view data at different zoom levels. For example, a teacher may view data in a city, and then “zoom-in” to view data within the school, and then “zoom-in” still further to view data within a classroom. Similarly, the teacher for example may also “zoom-out” to view data on larger scales. In this embodiment, the plurality of map images is linked together automatically by the management module 146. Following step 328, the process returns to step 322 to await input of another command.

By selecting the icon 228 on pop-up menu 224, the management module 146 is launched, enabling the facilitator to “set up” a group (step 330). Here, the facilitator may create a new group or edit an existing group, and may input or modify group information through interaction with the management module window 180. The group information may comprise, for example, a name of a class, a class room number, names of students in the class, and a class schedule. Once a group has been set up, the facilitator may then add participants to the group (step 332). Here, the facilitator may also input or modify participant information, such as for example student ID, student name, and tag strings. Once all participant information has been entered, the management module 146 then analyzes the tag strings of participants of the group (step 334).

FIG. 13B shows steps in the tag string analysis process carried out during step 334. Management module 146 first parses the tag string 280 of each participant into tags (step 350). The tags are identified by referring to the first delimiters 284. The management module 146 then partitions each tag into a keyword 288 and a tag value 290 by referring to the second delimiter 286. A list of unique keywords 288 is then generated from the parsed tags (step 352). The management module 146 then gets a keyword from the keyword list, starting with the first keyword in the keyword list (step 354). The management module 146 then identifies participants having a tag comprising the keyword 288 (step 356). The management module 146 then determines if the keyword is a spatial information keyword (step 358). In this embodiment, the spatial information keywords comprise “seat location”, “classroom location”, “postal code”/“zip code”, “GPS location”, and “mailing address”, however it will be understood that other spatial information keywords may of course be used. If the keyword 288 is not a spatial information keyword, the process proceeds to step 362. If the keyword 288 is a spatial information keyword, the management module 146 associates the tag values 290 with a relevant map image (step 360).

FIG. 13C shows steps in a tag value association process carried out during step 360. First, the management module 146 checks whether a map image relevant to the keyword is available (step 364). For example, if the keyword is “seat location”, the management module 146 searches the database 260 to determine if a room map image is available. As another example, if the keyword is “postal code” or “zip code”, the management module 146 searches the database 260 to determine if a city map image is available. If it is determined at step 364 that a relevant map image is available, the process proceeds to step 374. If it is determined at step 364 that no relevant map image is available, the management module 146 determines a value space for the keyword (step 366). The value space is a union of all unique tag values 290 associated with the keyword 288, as obtained during step 350. The management module 146 then proceeds to generate a map image based on the value space. Here, a shape is first applied for spatially representing the tag values 290 (step 368). In this embodiment, the shape is a rectangle. The management module 146 then determines the size of a grid based on the value space of the keyword (step 370), and applies the grid to the shape (step 372). For example, if the keyword is “seat location” having respective tag values expressed in the form of an X-Y coordinate set (X, Y), the management module 146 searches the value space to determine the largest values of X and Y, namely Xmax and Ymax. The shape is then partitioned into a grid of cells, the grid having Xmax rows and Ymax columns, and with each cell of the grid being defined as a hotspot. As another example, if the keyword is “postal code” having respective tag values expressed in the form of (A1A 1A1), the management module 146 searches the value space to determine a size S of the value space, namely the number of unique postal codes. The management module 146 then calculates two positive integers M and N, whereby the product of M and N is the smallest number larger than S. The shape is then partitioned into a grid of cells having M rows and N columns, with each cell of the grid being defined as a hotspot.

Tag values 290 of the keyword 288 are then associated with the relevant map image at corresponding hot spots (step 374). The management module 146 then checks to determine if all tag values 290 have been associated with the relevant map image (step 376). If yes, the process proceeds to step 382; otherwise, an orphan zone is created within the map image (step 378). Any tag value 290 that is not already associated with a corresponding hot spot of the map image is associated with the orphan zone (step 380). An empty legend zone is then created within the map image (step 382).

Turning again to FIG. 13B, following step 360, the management module 146 checks to determine if all keywords 288 in the keyword list have been processed (step 362). If all keywords 288 have not been processed, the process proceeds to step 354 to get the next keyword 288 from the keyword list. If all keywords 288 have been processed signifying completion of step 334, the data management process returns to step 322 to await input of another command.

Turning again to FIG. 13A, an assessment session is started by launching the assessment tool 144, if not already open, opening a desired assessment, and selecting a “start assessment” button (not shown) presented therein (step 336). Upon starting the assessment session, the questions of the assessment are transmitted to the response devices 26 (step 338). As participants enter responses to the questions using the response devices 26, the responses are then transmitted to the general purpose computing device 16 (step 340). When the assessment is finished, the facilitator ends the assessment (step 342). The general purpose computing device 16 then analyzes the received responses to determine response data. In this embodiment, the response data comprise whether or not participant responses are correct, participant scores for the assessment, and statistical results of the assessment for the group that are automatically calculated after the assessment (step 344). Following step 344, the process returns to step 322 to await input of another command.

A “show data” command may be entered at step 322 by selecting a “show data” button (not shown) presented by the management module 146, or a “show data” button (not shown) presented by the assessment tool 144. In this embodiment, the selected data comprises the response data generated during step 344. However, as will be understood, the selected data may be any data stored in the database 260 and selected by the facilitator for display. If the data selected for display is a statistical result that has not yet been calculated, the management module 146 calculates the statistical result and saves it in the database 260. Following step 346, the process returns to step 322 to await input of another command.

If a “quit” command is received at step 322, the process 310 ends (step 348).

FIG. 13D shows steps in a data plotting process carried out during step 346. Here, the management module 146 prompts the facilitator to select data that is to be displayed, to select one or more data display formats in which the data is to be displayed, and to select a spatial information keyword. The data display formats are any of numerical data and one or more graphical charts. In this embodiment, the graphical charts are any of a bar chart, a pie chart, a line chart, and a scatter chart. Once the data to be displayed, the one or more data display formats, and the spatial information keyword have been selected, the management module 146 retrieves the selected data from the database 260 and generates one or more charts showing the data in the selected one or more data display formats (step 402). The management module 146 then overlays the selected data in the one or more selected data display formats on the map image based on the tag values 290 associated with the selected spatial information keyword 288 (step 404). The management module 146 then creates one or more legends in the legend zone (step 406), and the map image and the overlaid data are displayed together as a data map on the display screen of the general purpose computing device 16 (and/or optionally on the interaction surface 34) (step 408).

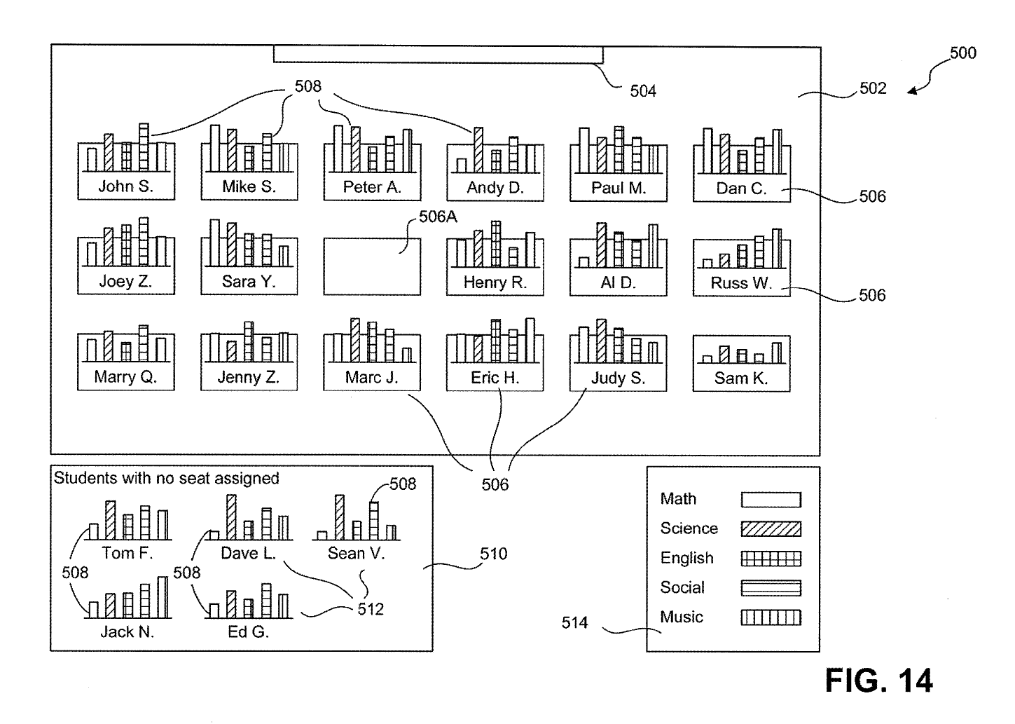

FIG. 14 shows an exemplary data map presented on the display screen of the general purpose computing device 16, and which is generally indicated by reference numeral 500. Data map 500 comprises a room map image 502 which, in the embodiment shown, is a classroom map. Room map image 502 has been generated using seat location tag values applied to a rectangular shape. The room map image 502 comprises a narrow rectangle 504 representing a blackboard for indicating the orientation of the classroom depicted in the room map image 502. In the embodiment shown, the room map image 502 comprises a 3×6 grid. Each cell of the grid corresponds to a seat 506, and is indicated by a rectangle, as shown. Each seat 506 that is associated with a participant has the name of the participant overlaid thereon. Each seat 506A that is not associated with a participant has no name overlaid. The data map 500 also comprises an orphan zone 510. In the embodiment shown, the orphan zone 510 comprises five participants 512 who are not associated with seats. Data map 500 also comprises a legend 514 in the legend zone. In the embodiment shown, data 508 selected by the facilitator for display is overlaid on the seats 506 and on participants 512 in the orphan zone 510.

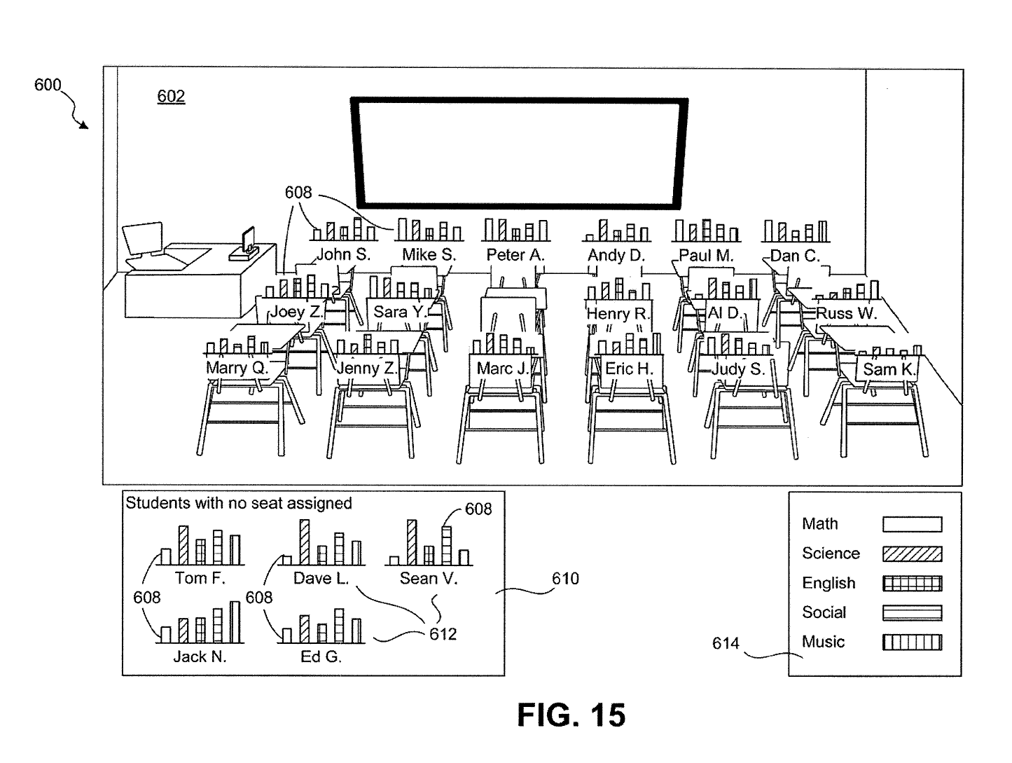

FIG. 15 shows another exemplary data map presented on the display screen of the general purpose computing device, and which is generally indicated by reference numeral 600. Data map 600 comprises a map image 602 which, in the embodiment shown, is an image of a classroom comprising seats. Hot spots have been associated with the seats shown in the map image 602. Data map 600 also comprises a legend 614 and an orphan zone 610. Data 608 selected by the facilitator for display is displayed on the hot spots associated with the map image 602 and with participants 612 in the orphan zone 610.

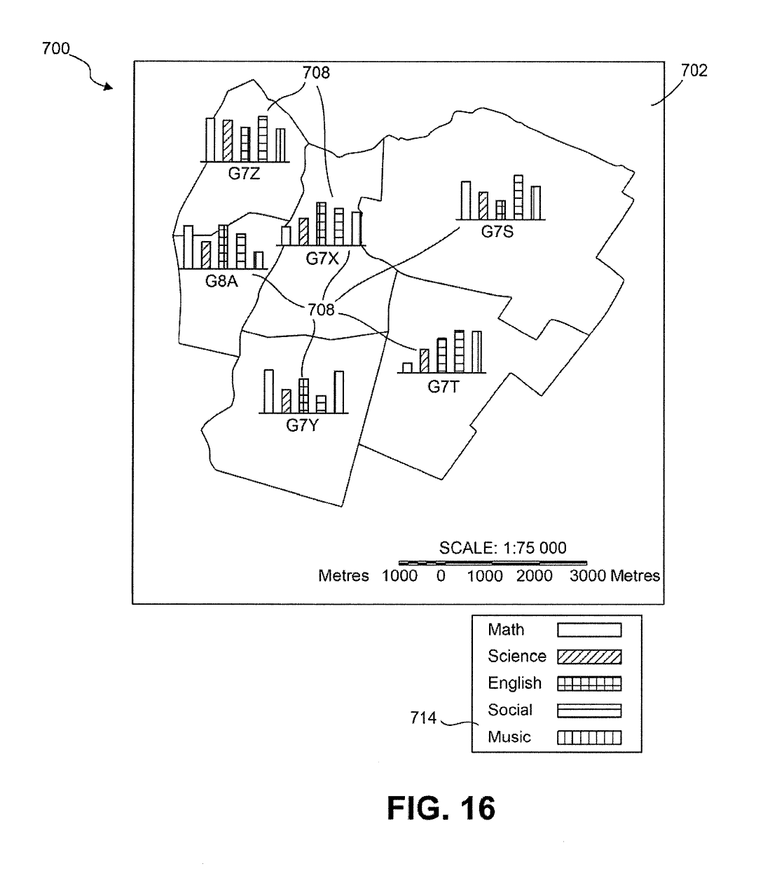

FIG. 16 shows yet another exemplary data map presented on the display screen of the general purpose computing device 16, and which is generally indicated by reference numeral 700. Data map 700 comprises a map image 702 which, in the embodiment shown, is an image of a city postal code map. Hot spots have been associated with postal code zones shown in the map image 702. Data 708 selected by the facilitator for display is displayed on the hot spots of the map image 702. Data map 700 also comprises a legend 714.

In this embodiment, map image 702 is a combined map image formed from a plurality of map images of smaller size that are linked and has a map structure over a range of scales for enabling the facilitator to view data 708 at different zoom levels. Here, the facilitator may “zoom-in” the map image 702 to generate a new data map showing data within a postal code zone, and may further “zoom-in” to generate a new data map showing data within a class room, as shown in FIG. 15, for example.

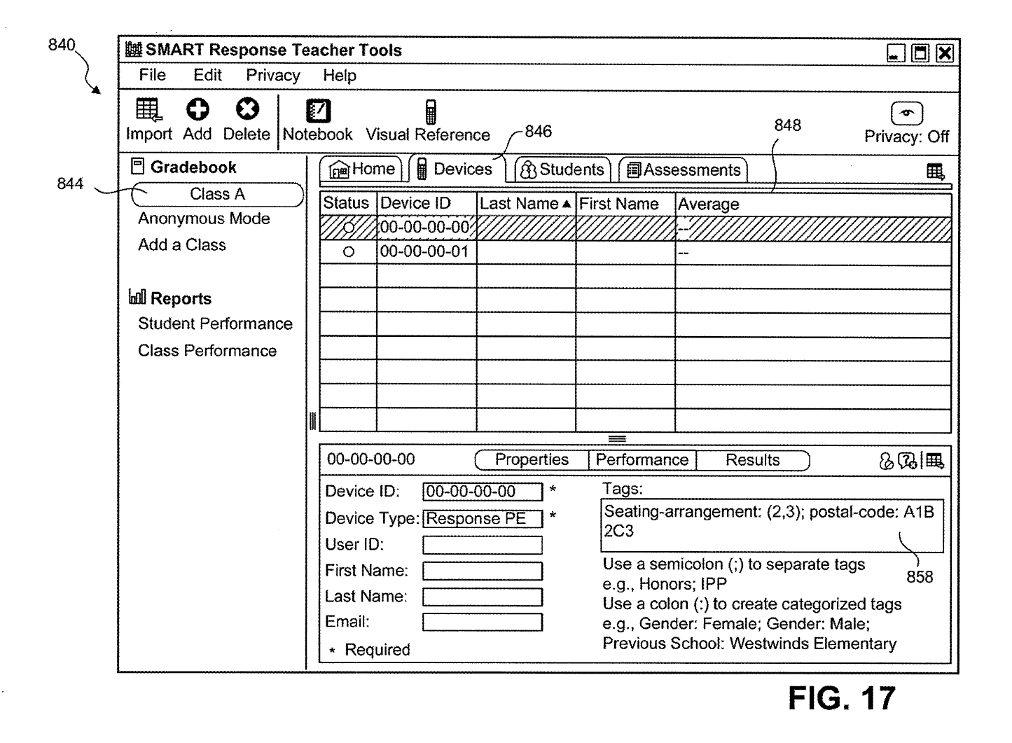

Although in embodiments described above, tags are set up for each participant, in other embodiments, tags may alternatively be set up for each response device 26. For example, FIG. 17 shows another embodiment of a management module window, and which is generally indicated by reference numeral 840. Management module window 840 comprises a “Devices” tab 846, which is selectable for displaying a list 848 of participant response devices 26 associated with a group selected from a group list 844. In the embodiment shown, the group list 844 comprises a single class “Class A”. Each of the participant response devices 26 in list 848 may be selected to view additional information about that response device. In the embodiment shown, the additional information comprises response device ID (e.g., the MAC address of the response device), response device type, and tags 858. Information may optionally be entered into user ID, user name and user email fields, and these fields may be left vacant if the response device is not assigned to a particular participant, for example.

In the embodiment shown in FIG. 17, tags 858 may be analyzed and used for determining response results data as described above. Tags comprising spatial information may be used to analyze the participant responses, and the response data may be overlaid on relevant map images.

In other embodiments, the management module may alternatively be configured to accept entry of a tag value without an associated keyword. During subsequent analyzing of tags, tag values not having an associated keyword are compared to a set of feasible tag values and feasible tag value formats, and an associated keyword is then determined for the tag value according to predefined rules. For example, instead of inputting a seat arrangement tag as “seat location: (2, 3)”, the facilitator may simply input a tag value of “(2, 3)”, and the associated keyword of “seat location” will be determined based on the tag value.

Although in embodiments described above, the value of the “seat location” tag is a set of seat coordinates, in other embodiments, the value of the “seat location” tag may alternatively be a seat number.

Although in embodiments described above, the spatial information tags comprise any of seat location, classroom location, postal code, and mailing address, it will be understood by those of skilled in the art that other tags may be used. For example, a tag “location” comprising tag values of “home” and “school” (e.g., “location: home”) may be used. As another example, a tag “location” comprising tag values of classroom names (e.g., “location: classroom 27” or “location: Computer Lab 3”) may also be used. As other examples, a “participant group” tag comprising tag values describing one or more participant groups may be used, and an “organization” tag comprising tag values describing one or more organizations may be used. It will be understood that still other tags may be used.

Although in embodiments described above, the tag keywords are entered by the facilitator, in other embodiments, the tag keywords may alternatively be previously defined.

Although in embodiments described above, spatial information of the participants is obtained from tags, in other embodiments, spatial information may alternatively be collected automatically from other sources. For example, in one related embodiment, a facilitator may set up a group and allow participants to join the group from one or more remote geographic locations. When participants join the group, the IP addresses of the response devices used by the participants are collected, and are then analyzed to determine the cities, provinces/states and countries of the participants. In still other embodiments, spatial information may be collected from other sources, such as, for example, by querying LDAP servers in the network, from a cellular network, from WiFi network location services, such as for example the Skyhook WiFi location service provided by Skyhook Wireless, and/or from Global Positioning System (GPS) devices incorporated into the response devices. In related embodiments, tags may be automatically generated based on the collected spatial information. For example, a GPS location tag may be automatically generated as “geo: 51.062770, −114.082139” for a response device equipped with a GPS device. Here, the tag values of automatically generated GPS location tags may be automatically updated in real-time.

As will be understood, the configurations of the host-side and client-side applications are not limited to those described above and in other embodiments, other configurations of the host-side and client-side applications may be used. For example, the host-side application 142 may reside and run on one or more servers, and may communicate with each other through a network. As another example, any of the assessment tool and the management module may alternatively be web applications running on one or more servers, and may provide one or more GUIs to the facilitator via a web browser on a computing device used by the facilitator. Similarly, the client-side applications may alternatively be web applications that run on one or more servers, and may provide a GUI to each participant via a web browser on each response device. As a further example, both host-side and client-side applications may be web applications that run on one or more servers, and may provide one or more GUIs to the facilitator and participants via web browsers.

Although in embodiments described above, the management module is used by the facilitator to set up groups, in other embodiments, the management module may alternatively be used by a system administrator to set up groups.

Although in embodiments described above, the management module associates the tag values with a relevant map image, in other embodiments, the management module may alternatively associate the tag values with a plurality of relevant map images.

Although in embodiments described above, the shape applied to the room is a rectangle, in other embodiments, other shapes may alternatively be applied to the room. In other embodiments, the shape may be chosen by a facilitator upon being prompted to choose a shape similar to the shape of the room.

Although in embodiments described above, the response devices comprise remote units and portable laptop or tablet computing devices, in other embodiments, the response devices may alternatively comprise other computing devices, such as, for example, smartphones, personal digital assistants etc. (PDAs). Here, the smartphones and/or PDAs would communicate with the general purpose computing device 16 wirelessly via the transceiver 22 or via other, commercial wireless transceivers such as wireless routers, or via wired connections such as for example Ethernet or Internet.

In other embodiments, the participant response system may be connected to a network and participant information, including tags, may alternatively be stored in a central database such that, when setting up a group, the facilitator may simply retrieve participant information from the central database and associate it with the group. Those skilled in the art will appreciate that instead of using tags, the system may alternatively provide the facilitator with an administrating tool for setting up fields of various types of participant information, allowing the facilitator to input participant information to corresponding fields.

Although the general purpose computing device is described as being physically connected to the IWB and transceiver via cables, the general purpose computing device may alternatively communicate with the IWB and transceiver over a wireless communication link.

It will be understood that in other embodiments, the keypad of the remote units may alternatively comprise a set of keys that is different from that of the embodiment described above, such as for example a full QWERTY key set or a DVORAK key set, or a subset thereof. If desired, the entire physical keypad or a portion thereof may be replaced with a touch screen overlying the LCD display to allow a user to interact with virtual keys.

Although in embodiments described above, the remote units are powered by any of batteries and a 110/220V source via a power cord, in other embodiments, the remote unit may be powered by any of a photovoltaic source and a manually cranked generator.

Although in embodiments described above, the facilitator is teacher, the participants are students of a class, the group is a class, and the assessment is a test, it will be understood that in other embodiments, the facilitator and the participants may be other persons, the group may alternatively be another grouping, and the assessment may alternatively be another form of assessing.

Although embodiments have been described above with reference to the accompanying drawings, those of skill in the art will appreciate that variations and modifications may be made without departing from the spirit and scope thereof as defined by the appended claims.

What is claimed is:

1. A method of presenting data gathered by a participant response system, comprising:
obtaining spatial information for participants;
collecting response data from the participants and generating result data;
overlaying said result data on a map image in accordance with the obtained spatial information to form a data map; and
displaying said data map.

2. The method of claim 1, wherein the spatial information comprises at least one of spatial coordinates and geographic coordinates of the participants.

3. The method of claim 1, wherein the map image comprises a plurality of map images linked to form a combined map image.

4. The method of claim 3, wherein the combined map image has a map structure over a range of scales for enabling said data map to be viewed at different zoom levels.

5. The method of claim 2, wherein the spatial information is stored as at least one tag forming part of a tag string created for each participant.

6. The method of claim 5, further comprising:
analyzing the tag strings; and
associating tags comprising the spatial information with the map image.

7. The method of claim 6, further comprising:
parsing the tag string of each participant into at least one tag; and
partitioning each tag into a keyword and a tag value.

8. The method of claim 7, further comprising creating the map image based on the tag values of tags comprising spatial information.

9. The method of claim 6, further comprising:
determining if all tags are associated to the map image; and
associating any tag not associated to the map image to an orphan zone.

10. The method of claim 1, wherein the spatial information is associated with at least one of a participant and a participant response device.

12. The method of claim 1, further comprising:
selecting data other than said result data to be displayed;
overlaying the selected data on the map image in accordance with the spatial information to form a second data map; and
displaying the second data map.

13. The method of claim 1 wherein the response data comprises answer data to at least one question.

14. The method of claim 13 further comprising, prior to said collecting, administrating an assessment to the participants, the assessment comprising the at least one question.

15. The method of claim 14 further comprising, analyzing the response data with regard to the answer to the at least one question to generate the result data.

16. The method of claim 15, wherein the spatial information comprises at least one of spatial coordinates and geographic coordinates of the participants.

17. The method of claim 15, wherein the map image comprises a plurality of map images linked to form a combined map image.

18. The method of claim 17, wherein the combined map image has a map structure over a range of scales for enabling said data map to be viewed at different zoom levels.

19. The method of claim 16, wherein the spatial information is stored as at least one tag forming part of a tag string created for each participant.

20. The method of claim 19, further comprising:
analyzing the tag strings; and
associating tags comprising the spatial information with a relevant map image.

21. The method of claim 20, further comprising:
parsing the tag string of each participant into at least one tag; and
partitioning each tag into a keyword and a tag value.

22. The method of claim 21, further comprising creating a map image based on the tag values of tags comprising spatial information.

23. The method of claim 20, further comprising:
determining if all tags are associated to the map image; and
associating any tag not associated to the map image to an orphan zone.

24. The method of claim 16, wherein the spatial information is associated with at least one of a participant and a participant response device.

25. The method of claim 15, further comprising:
selecting data other than said result data to be displayed;
overlaying the selected data on a map image in accordance with the spatial information to form a second data map; and
displaying the second data map.

26. A participant response system comprising:
a display;
a plurality of participant response devices, each participant response device configured to generate response data in response to user input; and
processing structure communicating with the display and the participant response devices, said processing structure being configured to:
analyze response data received from participant response devices and generate result data;
overlay the result data on a map image in accordance with spatial information to form a data map; and
display the data map on the display.

27. The system of claim 26, wherein the spatial information is associated with at least one of participants and participant response devices.

28. The system of claim 27, wherein the spatial information comprises at least one of spatial coordinates and geographic coordinates of the participants and/or participant response devices.

29. The system of claim 26, wherein the map image comprises a plurality of map images linked to form a combined map image.

30. The system of claim 29, wherein the combined map image has a map structure over a range of scales for enabling said data map to be viewed at different zoom levels.

31. The system of claim 28, wherein the spatial information is embodied as at least one tag forming part of a tag string created for each participant, and wherein the processing structure is configured to process the tags to determine the spatial information.

32. The system of claim 31, wherein the processing structure is further configured to:
analyze the tag strings; and
associate tags comprising spatial information with the map image.

33. The system of claim 32, wherein the processing structure is further configured to:
parse the tag string of each participant into at least one tag; and
partition each tag into a keyword and a tag value.

34. The system of claim 33, wherein the processing structure is further configured to create the map image based on tag values of tags comprising spatial information.

35. An apparatus comprising:
a display; and
processing structure communicating with the display, the processing structure executing program code causing the apparatus to:
analyze response data received from participant response devices and generate result data;
overlay the result data on a map image in accordance with spatial information to form a data map; and
display the data map on the display.

36. A computer-readable medium having embodied thereon computer program code which, upon execution by processing structure, causes an apparatus to:
collect response data from participant response devices and generate result data;
overlay said result data on a map image in accordance with spatial information to form a data map; and
display said data map.
